(19) United States
(12) Patent Application Publication
(10) Pub. No.: US 2006/0203004 A1
(43) Pub. Date: Sep. 14, 2006

(54) Display apparatus

(76) Inventors: Soon-hoon Hwang, Seongnam-si (KR); Hye-rim Kim, Suwon-si (KR)

Correspondence Address: STANZIONE & KIM, LLP, 919 18TH STREET, N.W., SUITE 440, WASHINGTON, DC, 20006, US

(21) Appl. No.: 11/368,646

(22) Filed: Mar. 7, 2006

(30) Foreign Application Priority Data
Mar. 8, 2005 (KR) 2005-19343

(51) Int. Cl. G09G 5/02

(52) U.S. Cl. 345/593

(57) ABSTRACT

The invention provides a display apparatus, including a display part to display an image thereon, a first image processor to change a format of an image signal to be displayable by the display part, a second image processor to change the signal output from the first image processor so that color display characteristics of the displayed image are variable, and a controller to control the first image processor to display a graphic user interface for adjusting the color display characteristics of the displayed image, and control the second image processor to adjust the color display characteristics of the displayed image based on a predetermined setting signal that is input via the graphic user interface.

### CROSS-REFERENCE TO RELATED APPLICATIONS

This application claims priority to and the benefit of Korean Patent Application No.10-2005-0019343, filed on Mar. 8, 2005 which is hereby incorporated by reference for all purposes as if fully set forth herein.

### BACKGROUND OF THE INVENTION

1. Field of the Invention

The present invention relates to a display apparatus, and more particularly, to a display apparatus that provides an improved user interface for adjusting color display characteristics of an image displayed on a display part.

2. Description of the Related Art

A display apparatus displays an image signal received externally or internally on a screen as an image.

Conventional display apparatuses are typically passive and receive the image signal from an image signal source such as a computer, a video player, a broadcasting signal, etc. and display the received signal as the image.

Recent developments in digital technology related to image processing techniques and improvements in chip integrity and processing speed have resulted in much research and development related to technology for improving display characteristics of the image displayed on the screen by reprocessing the image signal inputted to the display apparatus. Such technology has evolved to provide a function for adjusting the display characteristics of the image according to demands of various users. Thus, it is necessary that the display apparatus provide a convenient user interface for adjusting the display characteristics of the image by a user.

Accordingly, there is growing importance to develop the display characteristics of the image as inherent characteristics and to provide a user interface that is easily accessible by a user.

### SUMMARY OF THE INVENTION

The invention provides a display apparatus that improves color display characteristics of an image displayed on a display part, and provides a user interface that is easily accessible to adjust the color display characteristics.

Additional features of the invention will be set forth in the description which follows, and in part will be apparent from the description, or may be learned by practice of the invention.

The present invention discloses a display apparatus, including a display part to display an image thereon, a first image processor to change a format of an image signal to be displayable by the display part, a second image processor to change the signal output from the first image processor so that color display characteristics of the displayed image are variable, and a controller to control the first image processor to display a graphic user interface for adjusting the color display characteristics of the displayed image, and control the second image processor to adjust the color display characteristics of the displayed image based on a predetermined setting signal that is input via the graphic user interface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a display apparatus according to an embodiment of the invention.

FIGS. 2, 3, 4, 5, 6, 7 and 8 show various embodiments of a graphic user interface provided by the display apparatus according to an embodiment of the invention.

### DETAILED DESCRIPTION OF THE PREFERRED EMBODIMENT

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

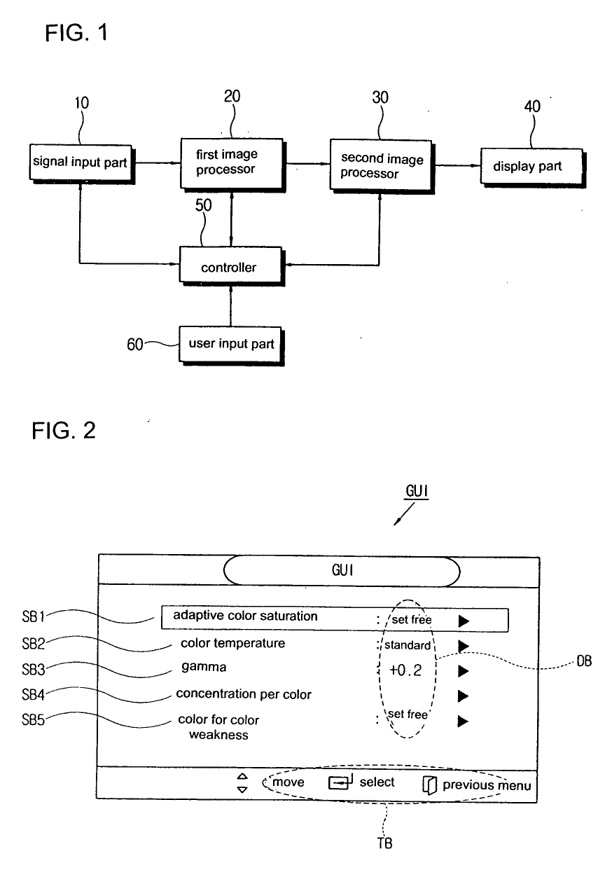

FIG. 1 is a control block diagram of a display apparatus according to an embodiment of the invention.

As shown in FIG. 1, a display apparatus includes a display part 40, a signal input part 10, a first image processor 20, a second image processor 30 and a controller 50.

The display part 40 receives an image signal from the second image processor 30 and displays an image thereon. The display part 40 may be provided as a flat panel display, e.g., a liquid crystal display (LCD) panel or a plasma display panel (PDP), or as a cathode ray tube (CRT).

The first image processor 20 changes the image signal received via the signal input part 10 into a signal in a format that is displayable by the display part 40 so that the signal may be output.

For example, the first image processor 20 may include a scaler to scale the image signal, and a signal changer to change the inputted video signal into a format that is processible by the scaler, e.g. digital signals of R, G and B.

The signal changer may include a transition minimized differential signaling (TDMS) receiver, an A/D (analog-to-digital) converter, a video decoder, a tuner, etc., corresponding to a video format of the image signal received via the signal input part 10.

The TDMS receiver divides a digital video signal, such as an external DVI signal, that is received via a digital connecting terminal (not shown) into the RGB digital signals and a HN synchronous signal and output these signals to the scaler. The A/D converter converts an analog video signal, such as a component signal or a PC signal inputted thereto, into the digital video signal and output the converted signal to the scaler. The video decoder decodes the analog video signal, e.g. a composite video baseband signal (CVBS) or an S-video signal, and outputs the decoded analog video signal to the scaler. The tuner receives the broadcast signal as an RF signal received from an antenna (not shown), etc. and output the broadcast signal to the video decoder.

For example, the signal input part 10 may include a digital connecting terminal, such as a DVI connector, a D-Sub connector, an antenna, an S-video terminal, a component terminal, etc., that corresponds with the video format of the inputted image signal.

The user input part 60 outputs a predetermined setting signal to the controller 50 according to a control or adjustment made by a user. According to an embodiment of the invention, the user input part 60 may include a control button and a key signal generator to generate a key signal corresponding to a key adjustment of the control button. The control button is preferably provided on a front side of the display apparatus.

The user input part 60 may further include a wireless remote controller to output a light signal according to an adjustment made by a user, and a light signal receiver provided in the display apparatus to receive the light signal output from the wireless remote controller and output a corresponding setting signal to the controller 50.

The second image processor 30 changes the image signal ouptut from the first image processor 20 so that the color display characteristics of the image displayed on the display part 40 vary according to a control of the controller 50, and outputs the changed image signal to the display part 40.

The color display characteristics, which are adjustable by the second image processor 30, may include at least one of adaptive color saturation, color temperature, gamma, concentration per color and colors for color weakness. The second image processor 30 uses a predetermined algorithm to adjust the respective color display characteristics. Specifically, the second image processor 30 adjusts the color display characteristics of the image displayed on the display part 40 by performing the respective algorithms according to a control of the controller 50.

The second image processor 30 adjusts the adaptive color saturation by adjusting various adaptive color saturation adjustment algorithms for realizing real colors such as improving the color saturation, e.g. improving the display characteristics of blue or red.

The second image processor 30 may include an algorithm for adjusting the adaptive color saturation with respect to all colors and an algorithm for adjusting the adaptive color saturation with respect to colors less at least one color, e.g. a skin color.

The color temperature, the gamma, the concentration per colors and the color adjustment for the color weakness, which are adjustable by the second image processor 30 and are described below.

As the image signal which is changed into a format that is displayable on the display part 40 by the first image processor 20, the scaler may adjust the image signal again through the predetermined algorithm to improve the color display characteristics of the image displayed on the display part 40 and the improved color image may be displayed on the display part 40.

Meanwhile, according to the present invention, the first image processor 20 may display a graphic user interface (GUI) for setting the color display characteristics that is adjusted by the second image processor 30 according to a control of the controller 50 on the display part 40. For example, the graphic user interface (GUI) may displayed on the display part 40 by a function performed by a scaler chip.

The controller 50 controls the second image processor 30 so that the graphic user interface (GUI) for setting the color display characteristics may be adjusted by the first image processor 20 to be displayed on the display part 40. The controller 50 controls the second image processor 30 so that the color display characteristics of the image displayed on the display part 40 are adjusted according to a predetermined setting signal that is input via the user input part 60 by using the graphic user interface (GUI).

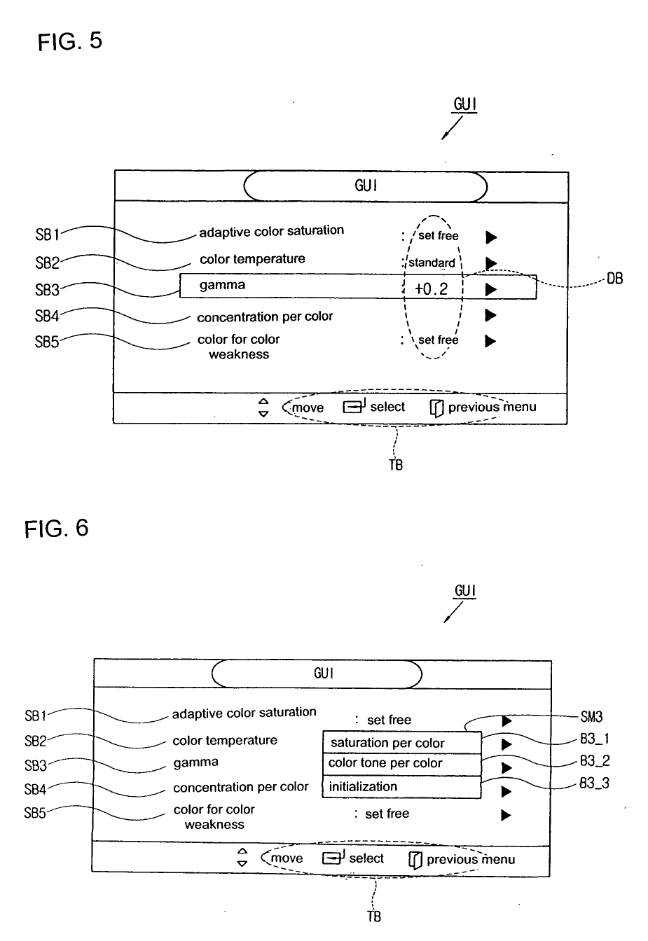

FIGS. 2, 3, 4, 5, 6, 7 and 8 show the operation of the graphic user interface (GUI) displayed on the display part 40 by the first image processor 20, the controller 50, the first image processor 20 and the second image processor 30 according to the input of the setting signal via the graphic user interface (GUI)according to an embodiment of the invention.

Referring to FIG. 2, when a predetermined button provided in the user input part 60 is selected, the controller 50 controls the first image processor 20 to display the graphic user interface (GUI) on the display part 40.

As previously described\, the graphic user interface (GUI) displayed on the display part 40 by the first image processor 20 includes a plurality of setting buttons SB1, SB2, SB3, SB4 and SB5 for adjusting the color display characteristics that are adjustable by the second image processor 30.

The setting buttons SB1, SB2, SB3, SB4 and SB5 of the graphic user interface (GUI) may include at least one of an adaptive color saturation setting button SB1 for adjusting the foregoing adaptive color saturation, a color temperature setting button SB2 for setting the color temperature, a gamma setting button SB3 for setting the gamma, a concentration per colors setting button SB4 for adjusting the concentration per colors and a color weakness setting button SB5 for setting the colors for the color weakness.

According to an embodiment of the invention, the first image processor 20 includes the algorithm for adjusting the adaptive color saturation, the color temperature, the gamma, the concentration per colors and the colors for the color weakness by way of example.

Accordingly, according to the embodiment shown in FIG. 2, the graphic user interface (GUI) includes the adaptive color saturation setting button SB1, the color temperature setting button SB2, the gamma setting button SB3, the concentration per colors setting button SB4 and the colors for the color weakness setting button SB5.

Additionally, a display block DB that displays information about a currently set value with respect to the color display characteristics corresponding to the respective setting buttons SB1, SB2, SB3, SB4 and SB5, is provided adjacent to the respective setting buttons SB1, SB2, SB3, SB4 and SB5.

Referring to FIG. 2, the display block DB corresponding to the adaptive color saturation setting button SB1 displays the state “set free” of the adaptive color saturation adjustment. The display block DB corresponding to the color temperature setting button SB2 displays the state “standard” of the color temperature. The display block DB corresponding to the gamma setting button SB3 displays “+0.2” of the gamma. The display block DB corresponding to the color for the color weakness setting button SB5 displays the state “set free” of the color adjustment function for the color weakness.

Referring to FIGS. 2, 3, 4, 5, 6, 7 and 8, a lower part of the graphic user interface (GUI) may display information about an adjustment method of the user input part 60 for a movement between the respective setting buttons SB1, SB2, SB3, SB4 and SB5, for a selection of items, and for a return to a previous menu, via an image and/or a text TB.

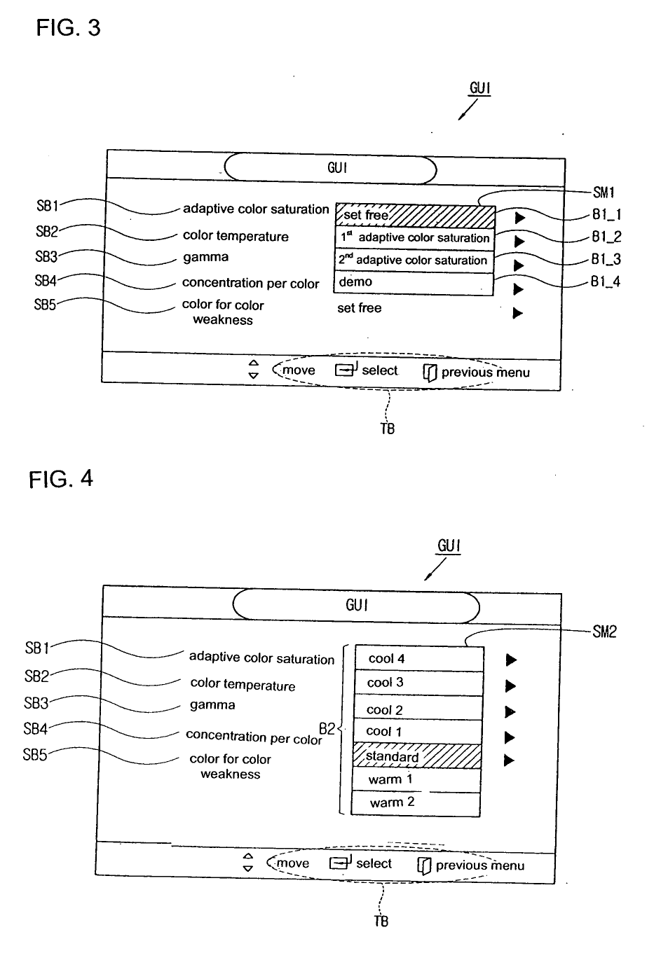

When the adaptive color saturation setting button SB1 displayed on the graphic user interface (GUI) is set via the user input part 60 as shown in FIG. 2, the controller 50 controls the first image processor 20 so that an adaptive color saturation sub menu SM1 is displayed on the display part 40 as shown in FIG. 3. The adaptive color saturation sub menu SM1 may overlap with the graphic user interface (GUI) shown in FIG. 2.

The adaptive color saturation sub menu SM1 may include a first adaptive color saturation setting button B1_2, a second adaptive color saturation setting button B1_3, a set-free button B1_1, and a demo button B1_4.

When the first adaptive color saturation setting button B1_2 is selected via the adjustment of the user input part 60, the controller 50 controls the second image processor 30 to adjust the adaptive color saturation with respect to all colors.

Meanwhile, when the second adaptive color saturation setting button B1_3 is selected via the adjustment of the user input part 60, the controller 50 controls the second image processor 30 to adjust the adaptive color saturation of the colors less at least one color, which is pre-set. For example, the color which is not performed with the adaptive color saturation adjustment according to selection of the second adaptive color saturation setting button B1_3 may be a skin color.

When the set-free button B1_1 is selected via the adjustment of the user input part 60, the controller 50 controls the second image processor 30 to set free the adaptive color saturation adjustment. For example, when a user selects the set-free button while the first adaptive color saturation setting button B1-2 or the second adaptive color saturation setting button B1_3 is selected to set the corresponding function, the controller 50 sets free the corresponding function, which is pre-set.

When the demo button B1_4 is selected via the adjustment of the user input part 60, the controller 50 controls the second image processor 30 to adjust the color display characteristics of the image displayed on a part of the display part 40 to the state corresponding to the selection of the first adaptive color saturation setting button B1_2. Also, the controller 50 controls the second image processor 30 to adjust the color display characteristics of the image displayed on another part of the display part 40 to the state corresponding to the selection of the set-free button B1_1. Accordingly, the image changed with the color display characteristics according to the selection of the first adaptive color saturation setting button B1_2 may be compared with the image when the color saturation setting function is set free, and the favorable color display characteristic may be selected.

When the demo button B1_4 is selected, the controller 50 may divide the image on the display part 40 into multiple parts to respectively display the foregoing images. Also, when the demo button B1_4 is selected, the controller 50 may control the second image processor 30 so that the image corresponding to the selection of the second adaptive color saturation setting button B1_3 and the image corresponding to the setting free are displayed on the display part 40.

When the color temperature setting button SB2 is selected via an adjustment of the user input part 60, the controller 50 controls the first image processor 20 so that the color temperature sub menu SM2 that is provided with a plurality of sub selection buttons B2 is displayed on the display part 40.

The respective sub selection buttons B2 displayed on the color temperature sub menu SM2 correspond to a level of the color temperature processed by the second image processor 30. For example, as shown in FIG. 4, the color temperature sub menu SM2 includes seven sub selection buttons B2. It is understood that any number of sub selection buttons may be provided corresponding to the numbers of the color temperature levels adjustable by the second image processor 30.

For example, when one of the sub selection buttons B2 in the color temperature sub menu SM2 is selected, the controller 50 controls the second image processor 30 to adjust the color temperature of the image displayed on the display part 40 to the level corresponding to the selected sub selection button B2.

When the gamma setting button SB3 is selected via an adjustment of the user input part 60, the controller 50 activates the gamma setting button SB3 so that the gamma is adjustable. Accordingly, the gamma may be adjusted via the adjustment of the user input part 60, e.g. through the adjustment of a direction key.

At this time, when a user adjusts the direction key of the user input part 60 while the gamma setting button SB3 is activated, the controller 50 controls the second image processor 30 to adjust the gamma by a predetermined level corresponding to the adjustment. The second image processor 30 may adjust the color display characteristics of the image displayed on the display part 40 according to the gamma of a plurality of levels.

When the gamma setting button SB3 is selected via the adjustment of the user input part 60, the controller 50 may control the first image processor 20 so that a gamma sub menu (not shown) provided with the sub selection button (not shown) corresponding to the gamma value adjustable by the second image processor 30 is displayed on the display part 40. The controller 50 may control the second image processor 30 to adjust the color display characteristics of the image displayed on the display part 40 according to the gamma corresponding to the selected sub selection button of the gamma sub menu.

Meanwhile, when the concentration per colors setting button SB4 is selected via the adjustment of the user input part 60, the controller 50 controls the first image processor 20 so that the concentration per colors sub menu SM3 provided with a saturation per colors setting button B3_1 for setting the saturation per colors and a color tone per colors setting button B3_2 for setting a color tone per colors is displayed on the display part 40.

When the saturation per colors setting button B3_1 is selected via the concentration per colors sub menu SM3, the controller 50 controls the first image processor 20 so that a color CB adjustable in color saturation by the second image processor 30 and a color saturation adjustment sub menu CM provided with a drag bar DB for adjusting the color concentration of the respective colors is displayed on the display part 40.

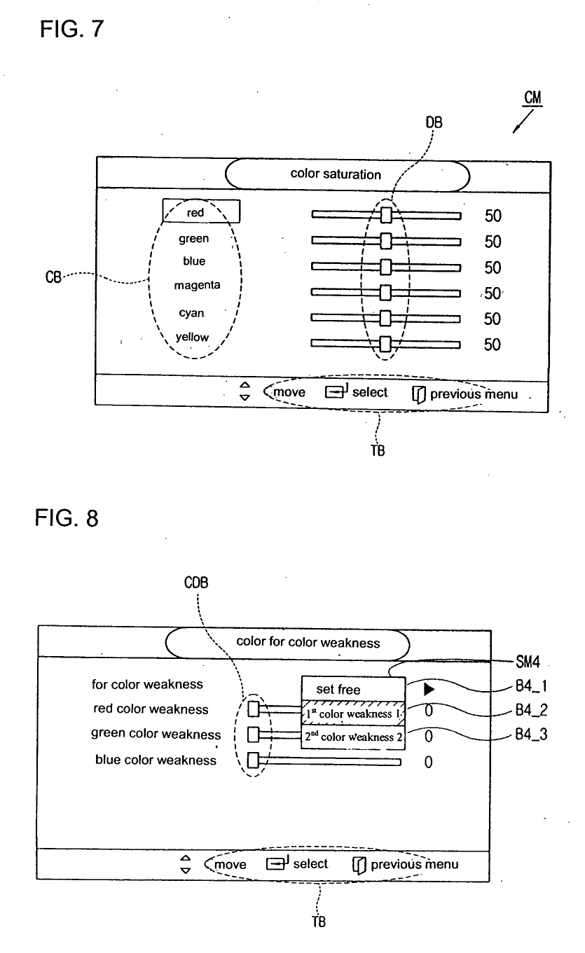

When the drag bar DB is dragged or pulled through the adjustment of the user input part 60, the controller 50 controls the second image processor 30 to adjust the color saturation of the corresponding color. The colors, which are adjustable by the second image processor 30, may include at least one of red, green, blue, magenta, cyan and yellow. As an example, FIG. 7 shows the foregoing six colors as the adjustable colors.

When the color tone per colors setting button B3_2 is selected via the concentration per colors sub menu SM3, the controller 50 controls the first image processor 20 so that a color tone adjustment sub menu (not shown) is displayed on the display part 40, which may be the same as when the color saturation per colors setting button B3_1 is selected. Here, the configuration and the adjustment process of the color tone adjustment sub menu will be avoided because they correspond to the color saturation adjustment sub menu CM.

When the color concentration per colors setting button SB4 is selected, the controller 50 may control the first image processor 20 so that the color concentration per colors that are preset via the color concentration per colors sub menu SM3 is displayed, e.g., an initialization button B3_3 for initializing the color saturation and the color tone on the color concentration per colors sub menu SM3, as shown in FIG. 6. When the initialization button B3_3 is selected, the controller 50 controls the second image processor 30 to initialize the preset concentration per colors into a predetermined value.

Meanwhile, when the colors for the color weakness setting button SB5 is selected, the controller 50 controls the first image processor 20 so that a color weakness sub menu SM4 is displayed on the display part 40.

The color weakness sub menu SM4 may include a set-free button B4_1 for setting free the colors for the color weakness; a first color weakness mode setting button B4_2 for setting a first color weakness mode; and/or a second color weakness mode setting button B4_3 for setting a second color weakness mode.

When the set-free button B4_1 is selected, the controller 50 controls the second image processor 30 to set free or turn off a preset mode with respect to the colors for the color weakness, e.g. the first color weakness mode or the second color weakness mode may be turned off.

When the first color weakness mode setting button B4_2 is selected, the controller 50 controls the first image processor 20 so that an adjustment sub menu AM for adjusting red, green and blue is displayed on the display part 40 as shown in FIG. 8. When a drag bar CDB corresponding to one of red, green and blue is dragged or pulled, the controller 50 controls the second image processor 30 to highlight the dragged color via the predetermined algorithm. Accordingly, an improved image may be provided to those users who have difficulty seeing a particular color.

The drag bar for the respective colors may be adjusted into a plurality of levels, e.g., ten levels, and the controller 50 may control the drag bar CDB to highlight the corresponding color via the predetermined algorithm for each level.

Meanwhile, the second color weakness mode may be used for setting a color weakness mode that is independent from the first color weakness mode.. For example, the first color weakness mode may be set as a red color weakness mode and the second color weakness mode may be set as a green color weakness mode. In addition, a level may be selected in the first color weakness mode and the second color weakness mode depending on the degree of the color weakness, e.g., amount of difficulty a user has seeing a particular color, with respect to the color weak for an identical color.

At this time, the controller 50 may store information about the first color weakness mode and the second color weakness mode in a memory, e.g. an electrically erasable and programmable read only memory (EEPROM) (not shown).

According to the foregoing embodiment, the first image processor 20 and the controller 50 may be arranged in the display apparatus, and the graphic user interface (GUI) may be generated by the first image processor 20. Further, predetermined software in a computer, which is connected with the display apparatus and applies the image signal, may generate the foregoing graphic user interface (GUI) to be displayed on the display apparatus. The predetermined software then applies a control signal to control the second image processor 30 to adjust the color display characteristics of the image according to a setting signal input via the user input part 60, such as a keyboard, a mouse, etc. that is connected with the computer, to the controller 50 of the display apparatus via the signal input part 10. The controller 50 may control the second image processor 30 to adjust the color display characteristics of the image based on the control signal. The controller 50 and the predetermined software of the computer may communicate through a DDC communication line, a USB communicable in two-way, or the like.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:,
a display part to display an image thereon;
a first image processor to change a format of an image signal to be displayable by the display part;
a second image processor to change the signal output from the first image processor so that color display characteristics of the displayed image are variable; and
a controller to control the first image processor to display a graphic user interface for adjusting the color display characteristics of the displayed image, and control the second image processor to adjust the color display characteristics of the displayed image based on a predetermined setting signal that is input via the graphic user interface.

2. The display apparatus of claim 1, wherein the color display characteristics adjustable by the second image processor comprises at least one of an adaptive color saturation, a gamma, a color temperature, a color concentration per color, and a color for color weakness for adjusting the color display characteristics of the displayed image via a predetermined algorithm, and
wherein the graphic user interface comprises at least one of an adaptive color saturation setting button for setting the adaptive color saturation, a color temperature setting button for setting the color temperature, a gamma setting button for setting the gamma, a color concentration per color setting button for setting the color concentration per color, and a color weakness setting button for setting a color for the color weakness.

3. The display apparatus of claim 2, wherein the controller controls the first image processor to display an adaptive color saturation sub menu on the display part when the adaptive color saturation setting button is selected, and
wherein the adaptive color saturation sub menu comprises:
a first adaptive color saturation setting button for adjusting the adaptive color saturation with respect to all colors,
a second adaptive color saturation setting button for adjusting the adaptive color saturation with respect to all colors except for at least one color,
a set-free button for setting free the adaptive color saturation adjustment, and
a demo button to compare the displayed image according to the selection of the first adaptive color saturation setting button or the second on the display part when the adaptive color saturation adjustment is set free via the set-free button.

4. The display apparatus of claim 3, wherein the controller controls the second image processor to adjust the color display characteristics of the displayed image to the state corresponding to when the first color saturation adjustment button or the second color saturation adjustment button is selected when the second adaptive color saturation setting button is selected, and
wherein the controller adjusts the color display characteristics of the image display on another part of the display part to the state corresponding to when the set-free button is selected.

5. The display apparatus of claim 3, wherein the controller controls the second image processor to adjust the color saturation of all colors except a skin color according to the predetermined algorithm when the second adaptive color saturation setting button is selected,.

6. The display apparatus of claim 2, wherein the controller controls the first image processor to display a color temperature sub menu provided with a plurality of sub selection buttons on the display part when the color temperature setting button is selected, and
wherein the controller controls the second image processor to adjust the color temperature of the displayed image to a level corresponding to the selected sub selection button when one of the plurality of sub selection buttons is selected.

7. The display apparatus of claim 2, wherein the second image processor adjusts the color display characteristics of the displayed image according to the gamma in plural levels, and
wherein the controller controls the first image processor to display a gamma sub menu provided with a sub selection button corresponding to the gamma of the respective levels and controls the second image processor to adjust the color display characteristics of the displayed image according to the gamma corresponding to the selected sub selection button of the gamma sub menu when the gamma setting button is selected.

8. The display apparatus of claim 2, wherein the controller controls the first image processor to display a color concentration per color sub menu provided with a color saturation per color setting button for setting the color saturation per color and a color tone setting button for setting a color tone per color when the color concentration per color setting button is selected.

9. The display apparatus of claim 8, wherein the color saturation per color sub menu further comprises:
an initialization button for initializing the color concentration per color preset through the color concentration per color sub menu, and
wherein the controller controls the second image processor to initialize the preset color concentration per color into a preset value when the initialization button is selected.

10. The display apparatus of claim 9, wherein colors adjustable in color concentration by the second image processor comprise at least one of red, green, blue, magenta, cyan and yellow.

11. The display apparatus of claim 10, wherein, the controller controls the first image processor to display a color saturation sub menu provided with a drag bar for adjusting the color adjustable in the color concentration and the color saturation of the respective colors on the display part when the color saturation per color setting button is selected through the color concentration per color sub menu, and
wherein the controller controls the second image processor to adjust the color saturation of the corresponding color according to a movement of the drag bar.

12. The display apparatus of claim 10, wherein the controller controls the first image processor to display a color tone sub menu provided with a drag bar for adjusting the colors adjustable in the color concentration and the color tone of the respective colors when the color tone setting button is selected through the color concentration per color sub menu, and
wherein the controller controls the second image processor to adjust the color tone of the corresponding color according to a movement of the drag bar.

13. The display apparatus of claim 2, wherein, the controller controls the first image processor to display a color weakness sub menu provided with a set-free button for setting free the color weakness adjustment, a first color weakness mode setting button for setting a first color weakness mode, and a second color weakness mode setting button for setting a second color weakness mode when the color weakness setting button is selected.
